(19) United States
(12) Patent Application Publication
(10) Pub. No.: US 2018/0095324 A1
(43) Pub. Date: Apr. 5, 2018

(54) DISPLAY MODULE AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Lulu LI, Beijing (CN); Guangquan WANG, Beijing (CN); Haiwei SUN, Beijing (CN); Tingting ZHAO, Beijing (CN); Enkai DONG, Beijing (CN); Zhiyong CHEN, Beijing (CN); Xuqing FENG, Beijing (CN)

(21) Appl. No.: 15/525,700

(22) PCT Filed: May 6, 2016
(86) PCT No.: PCT/CN2016/081270

§ 371 Date: May 10, 2017

(30) Foreign Application Priority Data
Feb. 4, 2016 (CN) 201610079254.6

(51) Int. Cl. G02F 1/1335; G06F 3/044

(52) U.S. Cl. CPC G02F 1/133528; G06F 2203/04112; G06F 3/044

(57) ABSTRACT

A display module and a display device are disclosed. The display module includes an array substrate and a color film substrate arranged opposite to each other, an upper polarizer located at a side of the color film substrate facing away from the array substrate, an attaching adhesive for attaching the upper polarizer to the color film substrate, the attaching adhesive comprising electrically conductive particles, and a silver adhesive connected with the attaching adhesive. The display module further includes an electrically conductive line arranged between the upper polarizer and the color film substrate. The electrically conductive line is electrically connected with the silver adhesive, and the attaching adhesive is electrically connected to the silver adhesive through the electrically conductive line.

### RELATED APPLICATIONS

The present application is the U.S. national phase entry of PCT/CN2016/081270, with an international filing date of May 6, 2016, which claims the benefit of Chinese Patent Application No. 201610079254.6, filed Feb. 4, 2016, the entire disclosures of which are incorporated herein by reference.

### TECHNICAL FIELD

The present disclosure relates to the field of display technology, particularly to a display module and a display device.

### BACKGROUND

When the display module has relatively large static electricity, the static electricity may break the circuit around the display panel, which may result in display abnormity, for example, being red, blue, abnormal display and even unable to display and the like. A touch display module comprises a touch display panel and a backlight module. When the touch display module has relatively large static electricity, the static electricity may burn out the integrated circuit (IC) of the touch display module or break the circuit around the touch display panel, which may result in display abnormity, for example, being red, blue, and even unable to display and the like.

### SUMMARY OF THE DISCLOSURE

An embodiment of the present disclosure provides a display module that includes an array substrate and a color film substrate arranged opposite to each other; an upper polarizer located at a side of the color film substrate facing away from the array substrate; an attaching adhesive for attaching the upper polarizer to the color film substrate. In certain embodiments, the attaching adhesive includes electrically conductive particles. The display module further includes a silver adhesive connected with the attaching adhesive. The display module further comprises an electrically conductive line arranged between the upper polarizer and the color film substrate. In certain exemplary embodiments the electrically conductive line is electrically connected with the silver adhesive, and the attaching adhesive is electrically connected to the silver adhesive through the electrically conductive line.

Because the above display module comprises an electrically conductive line arranged between the upper polarizer and the color film substrate, the electrically conductive line is electrically connected with the silver adhesive, and the attaching adhesive is electrically connected to the silver adhesive through the electrically conductive line, hence, the static electricity generated by the display module can be not only released through the conductive path of the electrically conductive attaching adhesive and the silver adhesive, but also released through the conductive path of the electrically conductive attaching adhesive, the electrically conductive line and the silver adhesive. Thus, the anti-static capability of the display module is improved.

According to another embodiment, the attaching adhesive is contracted due to an effect of external environment, and an orthographic projection area of the electrically conductive line on the color film substrate at least partly overlaps with an orthographic projection area of the attaching adhesive that is contracted due to the effect of external environment on the color film substrate.

Since the attaching adhesive can be conducted with the silver adhesive through the electrically conductive line after the attaching adhesive is contracted due to an effect of external environment, the static electricity generated after the attaching adhesive of an embodiment of the present disclosure is contracted due to the effect of the environment can still be released through the conductive path of the electrically conductive attaching adhesive, the electrically conductive line and the silver adhesive. Thus, the anti-static capability of the product is improved and the use performance and competitiveness of the product can be improved.

According to another embodiment, a material of the electrically conductive line is a silver adhesive.

According to another embodiment, a material of the electrically conductive line is a metal material. The metal material can be a composite material of molybdenum-aluminum-molybdenum.

According to another embodiment, a material of the electrically conductive line is a transparent electrically conductive material. The transparent electrically conductive material can be indium tin oxide, indium zinc oxide, or a composite material consisting of indium tin oxide and indium zinc oxide.

According to anther embodiment, a pattern shape of the electrically conductive line is an unclosed frame.

According to another embodiment, an edge shape of the frame is a zigzag.

According to another embodiment, a pattern shape of the electrically conductive line is a strip.

According to another embodiment, an edge shape of the strip shape is a zigzag.

According to another embodiment, a grounding portion is arranged on the array substrate, and the silver adhesive is electrically connected with the grounding portion.

According to a further embodiment, the display module is a touch display module, the touch display module comprising a touch electrode arranged between the array substrate and the color film substrate.

An embodiment of the present disclosure further provides a display device, the display device comprising the above display module.

### BRIEF DESCRIPTION OF THE DRAWINGS

FIG. 1 is a structural schematic view of ESD of an existing display module;

FIG. 2 is a structural schematic view of ESD of an existing touch display module;

FIG. 3 is a structural schematic view of a touch display module as shown in FIG. 2 after being influenced by external environment;

FIG. 4 is a structural schematic view of a display module provided by an embodiment of the present disclosure;

FIG. 5 is a structural schematic view of a display module provided by an embodiment of the present disclosure after being influenced by external environment;

FIGS. 6A and 6B are structural schematic views of pattern shapes of an electrically conductive line comprised by the display module provided by an embodiment of the present disclosure;

FIG. 7 is a structural schematic view of a touch display module provided by an embodiment of the present disclosure;

FIG. 8 is a structural schematic view of a touch display module provided by an embodiment of the present disclosure after being influenced by external environment.

### DETAILED DESCRIPTION OF THE DISCLOSURE

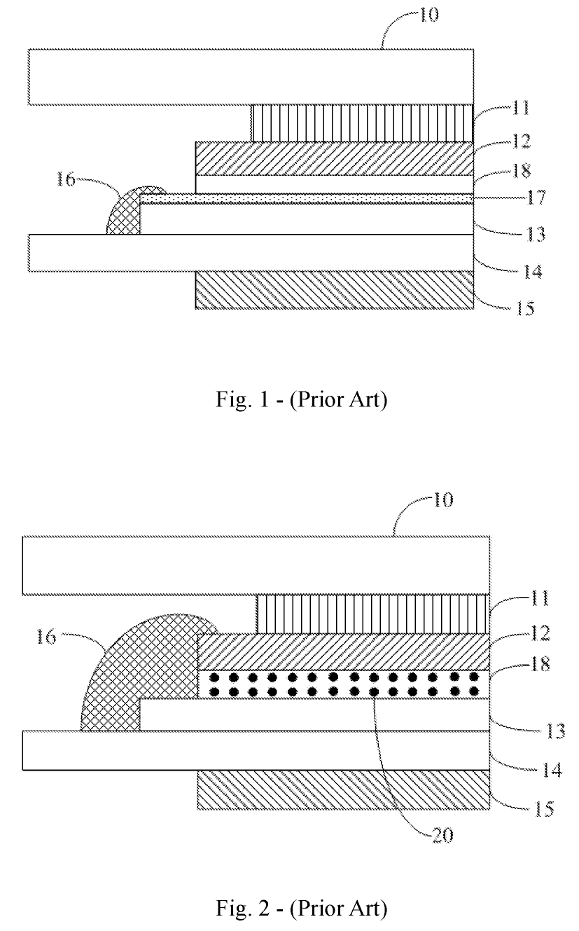

As shown in FIG. 1, the existing display module comprises an array substrate 14 and a color film substrate 13 arranged opposite to each other, an upper polarizer 12 arranged at a side of the color film substrate 13 facing away from the array substrate 14, a lower polarizer 15 arranged at a side of the array substrate 14 facing away from the color film substrate 13, a protective cover plate 10 for protecting the array substrate 14 and the color film substrate 13, a transparent optical adhesive 11 for adhering the protective cover plate 10 to the upper polarizer 12, and an attaching adhesive 18 for attaching the upper polarizer 12 to the color film substrate 13. The electro-static discharge (ESD) method used for this display module is: adding an indium tin oxide (ITO) film 17 or other conductive film at a side of the color film substrate 13 facing away from the array substrate 14. The ITO film 17 or other conductive film is connected with a grounding line in the IC circuit (not shown in the figure) on the array substrate 14 through a silver adhesive 16, so as to achieve the ESD function.

The above ESD method cannot be used in an in-cell touch display module, because the ITO film or other conductive film may shield the touch signal easily, which may result in insufficient touch signal amount, and cause poor touch. At present, only conductive materials within the particular resistance value range can avoid shielding the touch signal, however, it is difficult to acquire these materials in actual production.

In order to solve the above mentioned problem that the ITO film or other conductive film may shield the touch signal, the static electricity can be prevented by adding electrically conductive particles in the attaching adhesive 18. As shown in FIG. 2, electrically conductive particles 20 are added into the attaching adhesive 18, so as to enable the attaching adhesive 18 to become an electrically conductive attaching adhesive. The electrically conductive attaching adhesive is electrically connected with the silver adhesive 16, and the static electricity is released through the conductive path of the electrically conductive attaching adhesive and the silver adhesive, thereby achieve the ESD function.

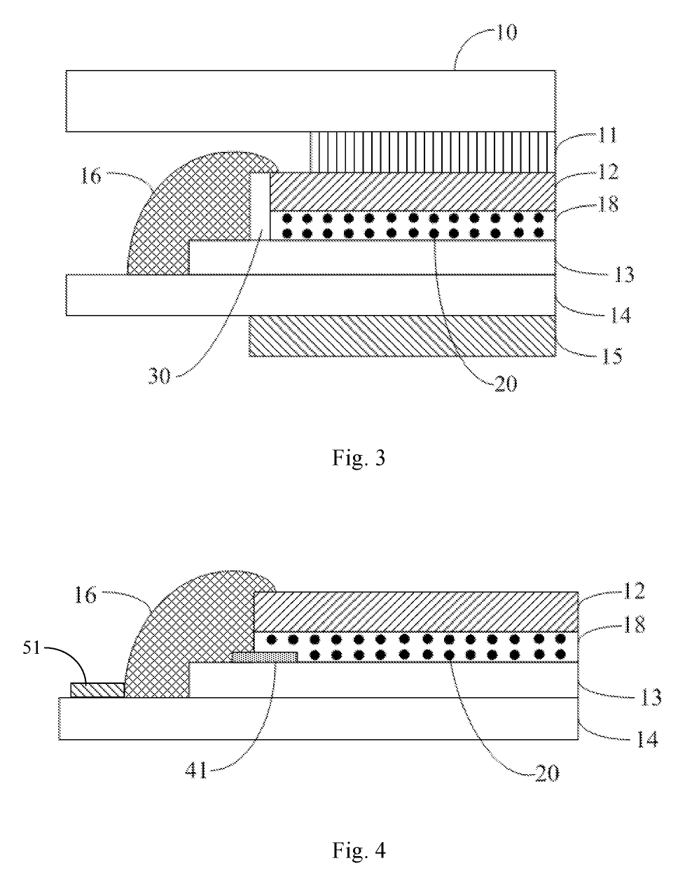

Although such a manner can achieve the ESD function to both the display module and the touch display module, in the process of actual use, however, the upper polarizer 12 and the attaching adhesive 18 may be easily influenced by external environment, such as being influenced by temperature, humidity etc. The upper polarizer 12 and the attaching adhesive 18 may be contracted after being influenced by external environment. As shown in FIG. 3, the contracted attaching adhesive 18 will be separated from the silver adhesive 16, so as to generate a gap 30. Hence, the conductive path of the electrically conductive attaching adhesive and the silver adhesive breaks, and the generated static electricity cannot be released well, which reduces the protective function of the ESD.

To sum up, the ESD method of adding an ITO film or other conductive film at a side of the color film substrate facing away from the array substrate is only applicable for a display module, but not applicable for a touch display module. Moreover, such a manner has to manufacture an ITO film or other conductive film separately, so the manufacturing cost is relatively high. Although the ESD method of adding electrically conductive particles in the attaching adhesive is applicable for both the display module and the touch display module, such a manner may be easily influenced by external environment in the process of actual use, which reduces the protective function of the ESD.

Therefore, it is desired to provide an improved display module and a display device, which can mitigate or avoid one or more of the above problems.

In order to enable the objects, the technical solutions and the advantages of the present disclosure to be clearer, next, the present disclosure will be described in more detail with reference to the drawings. Apparently, the embodiments described are only a part of rather than all of the embodiments of the present disclosure. Based on the embodiments in the present disclosure, all other embodiments obtained by the ordinary skilled person in the art without paying any creative work belong to the protection scope of the present disclosure.

Next, display modules provided by specific embodiments of the present disclosure will be described in detail with reference to the drawings.

The thicknesses, the area sizes and the shapes of films in the drawings do not reflect real proportions of the films, which only aim to schematically explaining the present disclosure.

As shown in FIG. 4, a specific embodiment of the present disclosure provides a display module, comprising: an array substrate 14 and a color film substrate 13 arranged opposite to each other; an upper polarizer 12 located at a side of the color film substrate 13 facing away from the array substrate 14; an attaching adhesive 18 for attaching the upper polarizer 12 to the color film substrate 13, the attaching adhesive 18 comprising electrically conductive particles 20; and a silver adhesive 16 connected with the attaching adhesive 18. The silver adhesive 16 can be used for conducting static electricity, for example. The display module provided by the specific embodiment of the present disclosure further comprises an electrically conductive line 41 arranged between the upper polarizer 12 and the color film substrate 13. The electrically conductive line 41 is electrically connected with the silver adhesive 16, and the attaching adhesive 18 is electrically connected to the silver adhesive 16 through the electrically conductive line 41.

According to another embodiment, the material of the electrically conductive line can be a silver adhesive, a metal material or a transparent electrically conductive material. When the material of the electrically conductive material is a metal material, the metal material can be a composite material of molybdenum-aluminum-molybdenum (Mo—Al—Mo), for example. When the material of the electrically conductive material is a transparent electrically conductive material, the transparent electrically conductive material can be indium tin oxide (ITO) material, indium zinc oxide (IZO) material, or a composite material consisting of indium tin oxide and indium zinc oxide, for example. Other electrically conductive materials can also be selected as the material of the electrically conductive line in the specific embodiment of the present disclosure. The specific materials of the electrically conductive line will not be defined here.

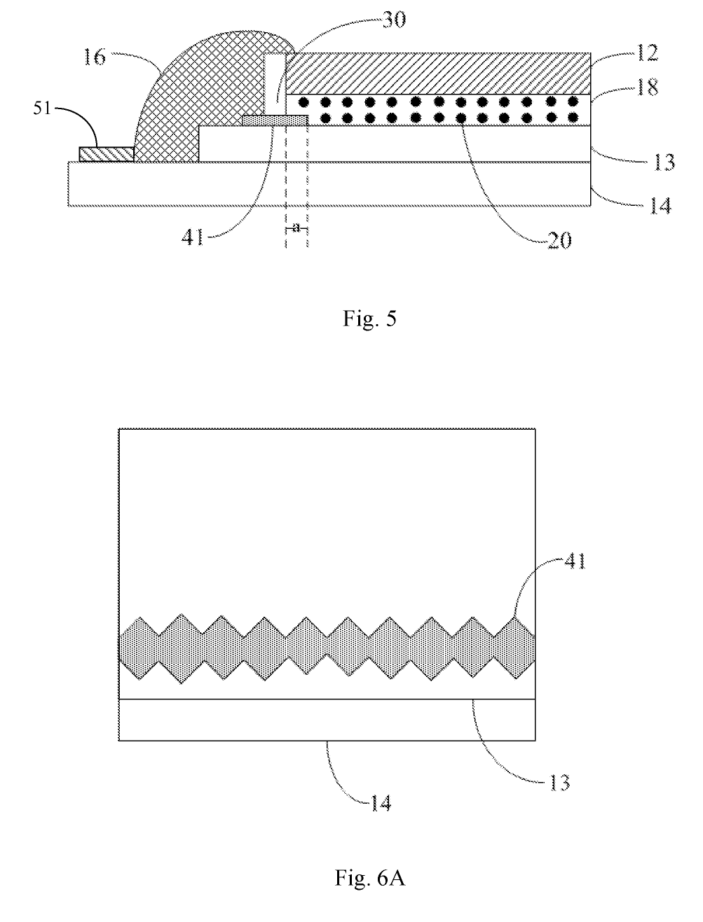

According to another embodiment, as shown in FIG. 5, the attaching adhesive 18 is contracted due to an effect of external environment, and an orthographic projection area of the electrically conductive line 41 on the color film substrate 13 at least partly overlaps with an orthographic projection area of the attaching adhesive 18 that is contracted due to the effect of external environment on the color film substrate 13. In FIG. 5, an overlapping area a is used to show overlapping between the orthographic projection area of the electrically conductive line 41 on the color film substrate 13 and the orthographic projection area of the attaching adhesive 18 that is contracted due to the effect of external environment on the color film substrate 13. A gap 30 is generated between the attaching adhesive 18 that is contracted due to an effect of external environment and the silver adhesive 16. As shown in FIG. 5, the electrically conductive line 41 in the display module for example can be arranged on the color film substrate 13. In specific implementation, the electrically conductive line 41 can be arranged on the color film substrate 13 by printing. Certainly, in the process of actual production, the electrically conductive line 41 can also be arranged on the color film substrate 13 by other ways. For example, the electrically conductive line 41 is arranged on the color film substrate 13 by coating.

As shown in FIGS. 4 and 5, a grounding portion 51 can be arranged on the array substrate 14, and the silver adhesive 16 is electrically connected to with the grounding portion 51. For example, the grounding portion 51 can be a grounding line in the IC circuit arranged on the array substrate 14.

As shown in FIG. 4, the static electricity generated by the display module of the specific embodiment of the present disclosure can be not only released through the conductive path of the electrically conductive attaching adhesive 18 and the silver adhesive 16, but also released through the conductive path of the electrically conductive attaching adhesive 18, the electrically conductive line 41 and the silver adhesive 16. In the process of use of the display module, the attaching adhesive 18 might be contracted due to an effect of external environment (e.g., temperature, humidity etc.), as shown in FIG. 5. In such a case, the static electricity generated by the display module of the specific embodiment of the present disclosure can be released through the conductive path of the electrically conductive attaching adhesive 18, the electrically conductive line 41 and the silver adhesive 16. Hence, the display module of the specific embodiment of the present disclosure can still release the generated static electricity after the attaching adhesive is contracted, thereby improving the anti-static capability of the product.

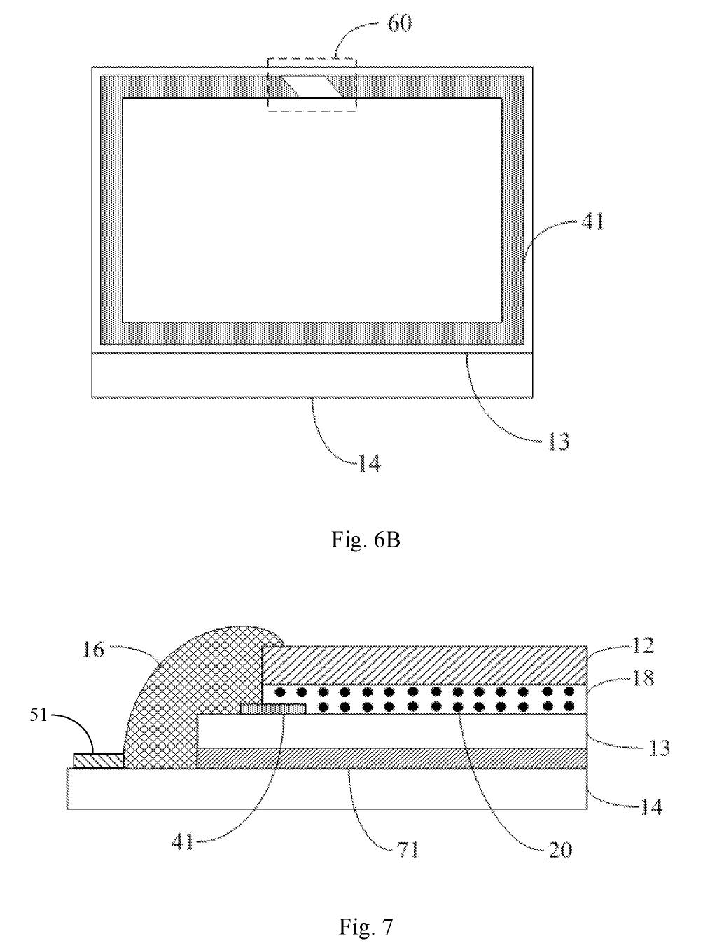

According to another embodiment, a pattern shape of the electrically conductive line can be a strip. In actual design, in order to conduct the static electricity better, for example, the edge shape of the strip can be set as a zigzag, as shown in FIG. 6A. Certainly, the pattern shape of the electrically conductive line in the specific embodiment of the present disclosure can also be an unclosed frame, as shown in FIG. 6B. The position of the unclosed area is as shown by the reference sign 60 in FIG. 6B. In actual design, the specific embodiment of the present disclosure does not define the specific position of the unclosed area. Compared to a closed frame of the pattern shape of the electrically conductive line 41, design of the pattern shape of the electrically conductive line 41 into an unclosed frame can avoid electromagnetic interference caused by the electrically conductive line to other devices in the display module excellently. In addition, in order not to influence conduction of the static electricity, the unclosed area should not be designed too large, which can be determined specifically based process condition of actual production. In actual design, in order to conduct the static electricity better, for example, the edge shape of the frame can be set as a zigzag. Certainly, in actual design, the shape of the electrically conductive line can be designed as other shape. The specific embodiment of the present disclosure does not define the specific shape of the electrically conductive line. When the pattern shape of the electrically conductive line is an unclosed frame, the static electricity generated by the display module in the specific embodiment of the present disclosure can also be released through the conductive path of the electrically conductive line and the silver adhesive in addition to being released through the conductive path of the electrically conductive attaching adhesive and the silver adhesive or through the conductive path of the electrically conductive attaching adhesive, the electrically conductive line and the silver adhesive.

As shown in FIG. 7, the display module in the specific embodiment of the present disclosure can be a touch display module having a touch function. The touch display module comprises: an array substrate 14 and a color film substrate 13 arranged opposite to each other; a touch electrode 71 arranged between the array substrate 14 and the color film substrate 13; an upper polarizer 12 located at a side of the color film substrate 13 facing away from the array substrate 14; an attaching adhesive 18 for attaching the upper polarizer 12 to the color film substrate 13, the attaching adhesive 18 comprising electrically conductive particles 20; and a silver adhesive 16 connected with the attaching adhesive 18. The silver adhesive 16 for example can be used for conducting static electricity. The touch display module in the specific embodiment of the present disclosure further comprises an electrically conductive line 41 arranged between the upper polarizer 12 and the color film substrate 13. The electrically conductive line 41 is electrically connected with the silver adhesive 16, and the attaching adhesive 18 is electrically connected with the silver adhesive through the electrically conductive line 41.

In specific implementation, the touch electrode arranged between the array substrate and the color film substrate can be a self-capacitance touch electrode. Alternatively, it can also be a mutual capacitance touch electrode. When the touch electrode is a self-capacitance touch electrode, the self-capacitance touch electrode can be arranged either at a side of the array substrate facing towards the color film substrate, or can be arranged at a side of the color film substrate facing towards the array substrate. The specific arranging manner of the self-capacitance touch electrode has been known, which will not be repeated here.

When the touch electrode is a mutual capacitance touch electrode, a driving electrode and a sensing electrode can be both arranged at a side of the array substrate facing towards the color film substrate. The driving electrode and the sensing electrode can also be both arranged at a side of the color film substrate facing towards the array substrate. Further, the driving electrode can be arranged at a side of the array substrate facing towards the color film substrate and the sensing electrode is arranged at a side of the color film substrate facing towards the array substrate. The specific arranging manner of the mutual capacitance touch electrode has been known, which will not be repeated here.

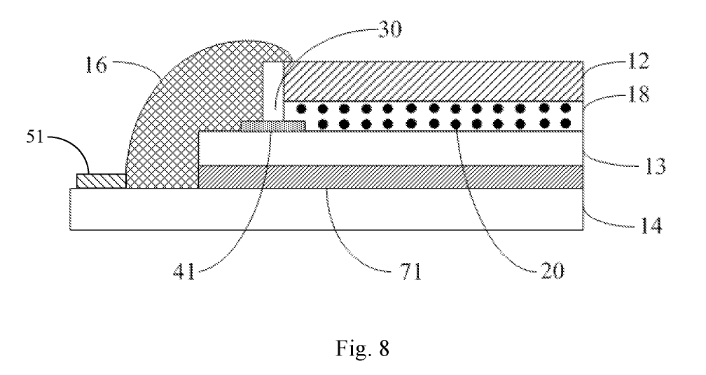

Specifically, as shown in FIG. 8, the attaching adhesive 18 is contracted due to an effect of external environment, and an orthographic projection area of the electrically conductive line 41 on the color film substrate 13 at least partly overlaps with an orthographic projection area of the attaching adhesive 18 that is contracted due to the effect of external environment on the color film substrate 13. A gap 30 is generated between the attaching adhesive 18 that is contracted due to an effect of external environment and the silver adhesive 16. As shown in FIG. 8, the electrically conductive line 41 in the display module for example can be arranged on the color film substrate 13. In specific implementation, the electrically conductive line 41 can be arranged on the color film substrate 13 by printing. Certainly, in the process of actual production, the electrically conductive line 41 can also be arranged on the color film substrate 13 by other ways. For example, the electrically conductive line 41 is arranged on the color film substrate 13 by coating or photo process.

As shown in FIGS. 7 and 8, a grounding portion 51 can be arranged on the array substrate 14, and the silver adhesive 16 is electrically connected with the grounding portion 51. For example, the grounding portion 51 can be a grounding line in the IC circuit arranged on the array substrate 14.

As shown in FIG. 7, the static electricity generated by the touch display module of the specific embodiment of the present disclosure can be not only released through the conductive path of the electrically conductive attaching adhesive 18 and the silver adhesive 16, but also released through the conductive path of the electrically conductive attaching adhesive 18, the electrically conductive line 41 and the silver adhesive 16. In the process of use of the display module, the attaching adhesive 18 might be contracted due to an effect of external environment (e.g., temperature, humidity etc.), as shown in FIG. 8. In such a case, the static electricity generated by the touch display module of the specific embodiment of the present disclosure can be released through the conductive path of the electrically conductive attaching adhesive 18, the electrically conductive line 41 and the silver adhesive 16. Hence, the touch display module of the specific embodiment of the present disclosure can still release the generated static electricity after the attaching adhesive is contracted, thereby improving the anti-static capability of the product.

A specific embodiment of the present disclosure further provides a display device, the display device comprising the above display module. The display device for example can be a display device such as a liquid crystal panel, a liquid crystal display, a liquid crystal television, an organic light emitting diode (OLED) panel, an OLED display, an OLED television or electronic paper etc.

To sum up, a specific embodiment of the present disclosure provides a display module, comprising an array substrate and a color film substrate arranged opposite to each other, an upper polarizer located at a side of the color film substrate facing away from the array substrate, an attaching to adhesive for attaching the upper polarizer to the color film substrate, the attaching adhesive comprising electrically conductive particles, and a silver adhesive connected with the attaching adhesive. The display module further comprises an electrically conductive line arranged between the upper polarizer and the color film substrate. The electrically conductive line is electrically connected with the silver adhesive, and the attaching adhesive is electrically connected to the silver adhesive through the electrically conductive line. Because the display module comprises an electrically conductive line arranged between the upper polarizer and the color film substrate, the electrically conductive line is electrically connected with the silver adhesive, and the attaching adhesive is electrically connected to the silver adhesive through the electrically conductive line, hence, the static electricity generated by the display module can be not only released through the conductive path of the electrically conductive attaching adhesive and the silver adhesive, but also released through the conductive path of the electrically conductive attaching adhesive, the electrically conductive line and the silver adhesive. Thus, the anti-static capability of the display module is improved.

Apparently, the skilled person in the art can make various modifications and variations to the present disclosure without departing from the spirit and the scope of the present disclosure. In this way, provided that these modifications and variations of the present disclosure fall within scopes of claims of the present disclosure and equivalent technologies thereof, the present disclosure also intends to encompass these modifications and variations.

1. A display module comprising:
an array substrate and a color film substrate arranged opposite to each other;
an upper polarizer located at a side of the color film substrate facing away from the array substrate;
an attaching adhesive for attaching the upper polarizer to the color film substrate, the attaching adhesive comprising electrically conductive particles; and
a silver adhesive connected with the attaching adhesive,
wherein the display module further comprises an electrically conductive line arranged between the upper polarizer and the color film substrate, and
wherein the electrically conductive line is electrically connected with the silver adhesive, and the attaching adhesive is electrically connected to the silver adhesive through the electrically conductive line.

2. The display module according to claim 1, wherein the attaching adhesive is contracted due to an effect of external environment, and an orthographic projection area of the electrically conductive line on the color film substrate at least partly overlaps with an orthographic projection area of the attaching adhesive that is contracted due to the effect of external environment on the color film substrate.

3. The display module according to claim 1, wherein a material of the electrically conductive line is a silver adhesive.

4. The display module according to claim 1, wherein a material of the electrically conductive line is a metal material.

5. The display module according to claim 4, wherein the metal material is a composite material of molybdenum-aluminum-molybdenum.

6. The display module according to claim 1, wherein a material of the electrically conductive line is a transparent electrically conductive material.

7. The display module according to claim 6, wherein the transparent electrically conductive material is indium tin oxide, indium zinc oxide, or a composite material consisting of indium tin oxide and indium zinc oxide.

8. The display module according to claim 1, wherein a pattern shape of the electrically conductive line is an unclosed frame.

9. The display module according to claim 8, wherein an edge shape of the frame is a zigzag.

10. The display module according to claim 1, wherein a pattern shape of the electrically conductive line is a strip.

11. The display module according to claim 10, wherein an edge shape of the strip shape is a zigzag.

12. The display module according to claim 1, wherein a grounding portion is arranged on the array substrate, and wherein the silver adhesive is electrically connected with the grounding portion.

13. The display module according to claim 1, wherein the display module is a touch display module, the touch display module comprising a touch electrode arranged between the array substrate and the color film substrate.

14. A display device comprising the display module according to claim 1.

15. The display module according to claim 2, wherein the display module is a touch display module, the touch display module comprising a touch electrode arranged between the array substrate and the color film substrate.

16. The display module according to claim 8, wherein the display module is a touch display module, the touch display module comprising a touch electrode arranged between the array substrate and the color film substrate.

17. The display module according to claim 9, wherein the display module is a touch display module, the touch display module comprising a touch electrode arranged between the array substrate and the color film substrate.

18. The display module according to claim 10, wherein the display module is a touch display module, the touch display module comprising a touch electrode arranged between the array substrate and the color film substrate.

19. The display module according to claim 11, wherein the display module is a touch display module, the touch display module comprising a touch electrode arranged between the array substrate and the color film substrate.

20. The display module according to claim 12, wherein the display module is a touch display module, the touch display module comprising a touch electrode arranged between the array substrate and the color film substrate.
